(19) United States
(12) Patent Application Publication
(10) Pub. No.: US 2025/0056525 A1
(43) Pub. Date: Feb. 13, 2025

(54) TRAFFIC SCHEDULING PATTERN LEARNING

(71) Applicant: Telefonaktiebolaget LM Ericsson (publ), Stockholm (SE)

(72) Inventors: Christian Braun, Vallentuna (SE); Hao Zhang, Guangdong (CN); Anders Widebrant, Lund (SE); Magnus Malmberg, Loderup (SE); Peter Jakobsson, Lund (SE); Sarat Kalyanam, Lund (SE)

(21) Appl. No.: 18/720,839

(22) PCT Filed: Dec. 17, 2021
(86) PCT No.: PCT/IB2021/000899

§ 371 Date: Jun. 17, 2024

(51) Int. Cl. H04W 72/12; H04W 24/08; H04W 72/0446; H04W 72/0457; H04W 72/20

(52) U.S. Cl. CPC H04W 72/12; H04W 24/08; H04W 72/0446; H04W 72/0457; H04W 72/20

(57) ABSTRACT

Methods and systems are described for injecting a signal, such as a test or calibration signal, into data sent by a scheduling unit to a radio unit in a radio access network. Monitoring, mapping, and/or prediction of data traffic can be carried out by components of the radio unit. It can then be determined what injection points for the signal will do the least harm to the regular data traffic.

### TECHNICAL FIELD

The present disclosure generally relates to the technical field of wireless communications and antenna calibration.

### BACKGROUND

Massive MIMO (multiple input multiple output) radios require run-time antenna calibration (AC) functionality in order to create and maintain phase coherent radio branches. This is a pre-requisite for proper beamforming function. The AC function includes regular measurement procedures that sends an AC specific test signal through the physical branches of the radio. During this time the regular traffic needs to be interrupted. This interruption can be done blindly, i.e., the ongoing traffic is interrupted and overwritten during a few symbols where AC signals are transmitted in its place. This blind interrupt can be done at a low layer, in the layer one (L1) function. The blind inject means that ongoing transmission is disturbed and may require retransmission because too much error is introduced to the traffic. This has a negative impact on the total throughput because the retransmission is done for larger data blocks, even though the actual interrupt was only a few symbols. The interruption can also be done scheduler-aware (or scheduler-driven), meaning that the scheduler function clears ongoing traffic allowing for AC signals to be transmitted without overwriting ongoing traffic since it is already cleared by the scheduler function. In this solution, the traffic clearing is done on a higher layer, layer three (L3), whereas the AC signals are still injected by the low layer L1 function. The scheduler-aware (or scheduler-driven) solution requires no retransmissions, and the impact on throughput is therefore significantly smaller.

### SUMMARY

One embodiment under the present disclosure comprises a method performed by a radio unit for semi-blindly interrupting traffic signals. The method can comprise: monitoring one or more traffic signals sent by a scheduling entity; predicting traffic levels in one or more time slots of the one or more traffic signals based on the monitoring; and injecting the traffic interruption in a time slot with a low predicted traffic level.

Another embodiment can comprise a method performed by a radio unit for inserting a traffic interruption. This method can comprise: predicting a PRB utilization by analyzing a control signal region of one or more traffic signals from a scheduling unit; selecting a time when injection of the test signal will result in minimal harm to the one or more traffic signals; and injecting the traffic interruption at the selected time.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIGS. 1A-1D show a diagram of PRB utilization summation;

FIG. 2 shows a table of unused symbol indications;

FIG. 3 shows a table of unused symbol indications;

FIG. 4 shows a schematic diagram of a radio device under the present disclosure;

FIG. 5 shows a flow-chart diagram of a method embodiment under the present disclosure;

FIG. 6 shows an example traffic load plot for low traffic load;

FIG. 7 shows an example traffic load plot for medium traffic load;

FIG. 8 shows an example traffic load plot for high traffic load;

FIG. 9 shows a schematic diagram of control region traffic under the present disclosure;

FIG. 10 shows an example traffic load plot of control regions under the present disclosure;

FIG. 11 shows a flow-chart of a method embodiment of the present disclosure;

FIG. 12 shows a flow-chart of a method embodiment of the present disclosure;

FIG. 13 shows a flow-chart of a method embodiment of the present disclosure;

FIG. 14 shows a radio device embodiment under the present disclosure; and

FIG. 15 shows a communication network embodiment under the present disclosure.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

In many radio access network (RAN) systems for Massive MIMO radios, the L1 function resides on the radio unit (RU) side, whereas the L3 function resides on the digital unit (DU) side (or a scheduling entity or device). AC specific interaction between L1 and L3 for scheduler-aware AC injections are often handled by proprietary signaling between components from the same company/vendor. Although L1-L3 signaling adds complexity for standalone systems, it is still feasible with a proprietary signaling solution. It can however provide huge implementation problems for open RAN (ORAN) systems, in which the open DU (O-DU) and open RU (O-RU) can come from different vendors. The ORAN standard contains AC specific signaling for the purpose of synchronizing AC events. However, the signaling schemes in the ORAN standard are not easy to interpret let alone implement, and there is little room for adaptation to special needs and different implementation from different vendors. Therefore, there is a clear risk that equipment from different vendors will be incompatible in this sense. There is a possibility to revert to a blind AC inject scheme that requires no interaction and communication between O-DU and O-RU. There is however a risk that this solution will yield an unacceptable penalty on cell throughput due to large overhead of retransmissions.

Proposed solutions and embodiments under the present disclosure include semi-blind approaches to the above-described problem. In some embodiments, for example, the O-RU side can monitor and map the scheduling patterns of the O-DU. The O-RU can do this by monitoring the averaged actual utilization of the user plane and control plane data as sent from/to the O-DU. This can include the LLS-U and LLS-C. LLS-U is the Lower Layer Split User-plane, the logical interface between O-DU and O-RU when using a lower layer functional split. LLS-C is the Lower Layer Split Control-plane, the logical interface between O-DU and O-RU when using a lower layer functional split. This pattern represents the average scheduling utilization as mapped on a time-frequency grid of e.g., LTE (long term evolution) or NR (new radio) radio frames. The average traffic utilization map can expose the O-DU scheduling patterns and placement of sensitive control channels and reference signals to the O-RU without any need of special signaling between them. It provides for improved O-RU standalone solutions regarding AC signal inject. Knowledge of the scheduling patterns can be utilized to inject AC signals in positions where they do least harm to the ongoing traffic. Since the average utilization is based on historical data, it might not guarantee that an AC inject does not overwrite ongoing traffic, but based on likelihood, it can provide a better solution compared to a fully blind AC inject. The O-RU can decide optimal (or semi-optimal) injection of AC signal based on measurement and analysis of past and current traffic data. By optimal it is meant that minimum impact to ongoing traffic is achieved. O-RU measures the traffic utilization and maps it to an average PRB utilization table. This table shows the average PRB utilization over a radio frame with per-symbol resolution. The resolution in frequency-domain can be per PRB or coarser, up to per the full carrier bandwidth. The averaging method is based on a sliding window in time domain, longer or shorter time windows can be used. Preferably, separate tables are created for DL and UL directions. The utilization tables can be used to decide the best anticipated injection point for AC signals, and can be used both for inject in the DL stream (DL AC) and UL stream (UL AC). The measurement of average utilization can be based on monitoring O-RAN C-plane messaging (C-plane messaging is sent ahead of time from O-DU to O-RU to describe upcoming U-plane transmissions) or direct measurements of the IQ payload utilization (O-RAN U-plane). For direct measurement of the IQ payload, the measurement can be done on frequency domain IQ data, in DL before the iFFT (inverse fast Fourier transform), and in UL after the FFT (fast Fourier transform). It is also possible to perform the measurement in the time domain, after DL iFFT and before UL FFT.

In addition, embodiments under the present disclosure include solutions based on control region analysis to predict empty or unused traffic symbols/PRBs (physical resource blocks) and inject the AC signals accordingly. This can reduce the traffic impact further.

Embodiments under the present disclosure include injecting of a test signal, such as for antenna calibration. But the present disclosure can also be applied to other functions that can benefit from a similar approach e.g., overtemperature handling (forced less), if an O-RU requested and O-DU controlled reduction in scheduled traffic cannot be achieved in the ORAN architecture. Some embodiments, such as in overtemperature handling, my comprise an injection of silence, or a traffic interrupt, instead of injecting a test or other signal. In cases of overtemperature handling the O-RU may request the O-DU to de-schedule traffic to allow hardware and/or components to cool down and/or turn off power, either temporarily or for sustained periods. In some embodiments, the O-RU, instead of sending a request to the O-DU to de-schedule traffic, may utilize any of the prediction and/or mapping techniques described in the present disclosure to identify or predict a time or frequency slot of low traffic and then perform an injection of silence or a traffic interrupt.

Another possible embodiment under the present disclosure can comprise an injection of a test signal for PIM (passive intermodulation) distortion. Test signals for both AC and PIM can both be unique and orthogonal for each carrier branch of an antenna(s). However, in the case of AC this uniqueness helps to allow for comparing phase difference between individual branches in one carrier bandwidth. For PIM this uniqueness helps to enable the measurement of leakage from branches in one carrier bandwidth onto branches in another carrier bandwidth. For both AC and PIM, the injected signal is preferably short. In comparison, in situations of injecting silence or otherwise performing a traffic interrupt, the injected silence or interrupt can be longer.

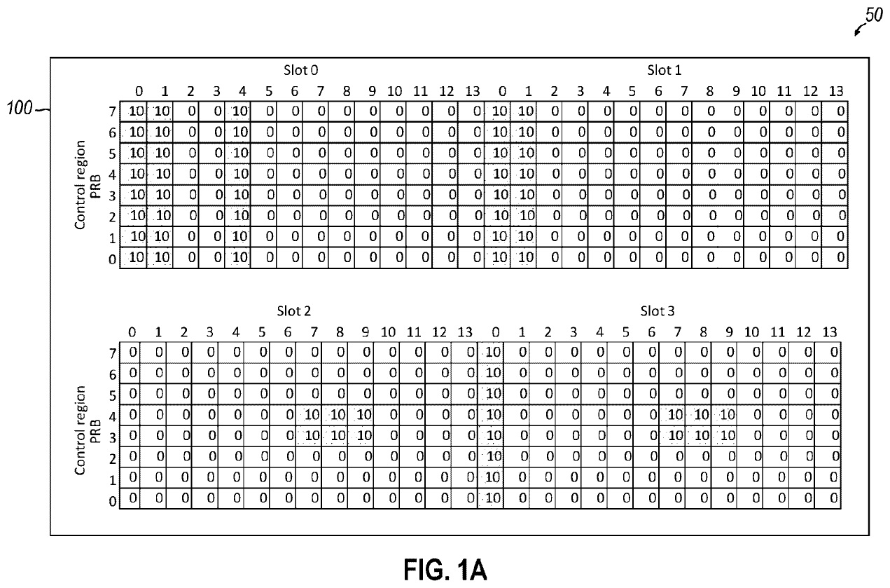

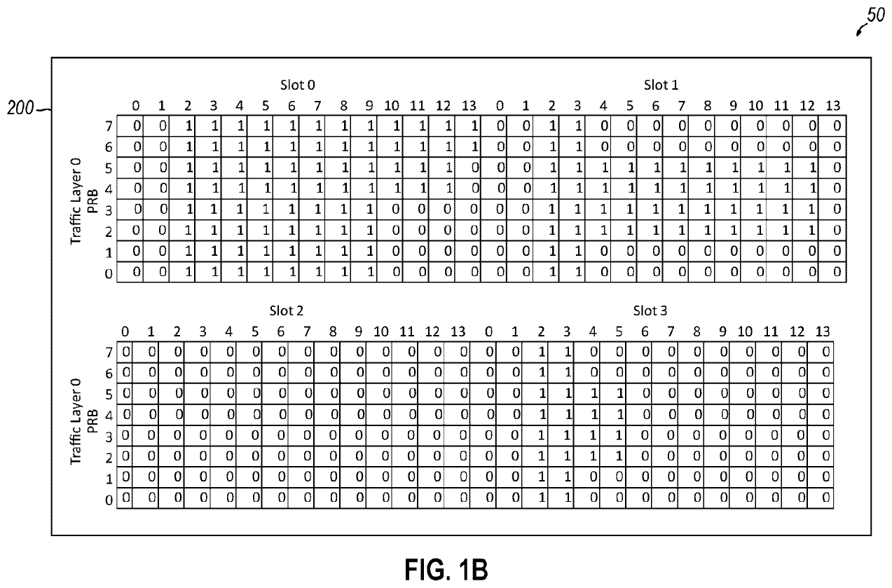

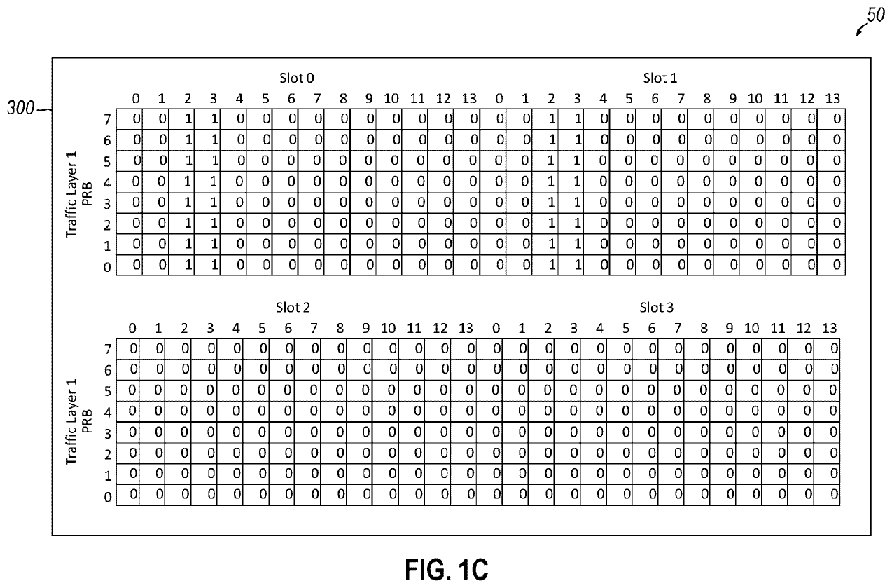

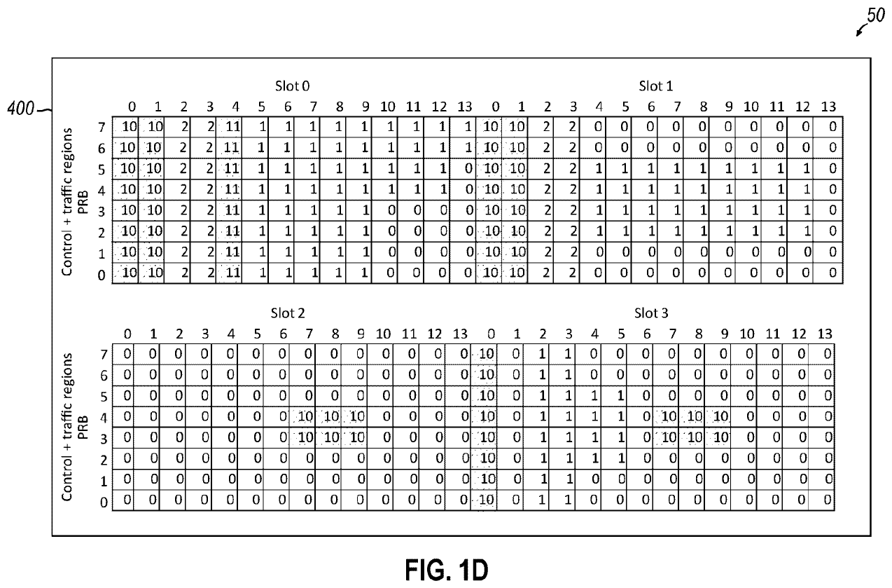

FIGS. 1A-1D show an example average PRB utilization map 50 for slots in a radio frame. Utilization map 50 shows control region 100 (FIG. 1A), traffic layers 200, 300 (FIGS. 1B-1C), and summation 400 (FIG. 1D), which sums the traffic from the other levels/regions. In embodiments under the present disclosure, the O-RU can map the scheduled traffic, such as in FIGS. 1A-1D, as the average utilization of each PRB in the time-frequency grid of the air interface. This can be done separately for DL and for UL directions. Typically, the transmission for Massive MIMO radio occurs in multiple layers simultaneously, which is something the utilization map can consider by simply summing the allocation for all layers, as shown in FIG. 1D. The fields of FIGS. 1A-1D are shaded for visualization. In this example the PRB utilization is shaded so that 0 utilization has white fill, and the higher utilization, the darker the PRB becomes. Blocks in the control regions are weighted with 10 so that they have higher priority in the total utilization map. This is a way to give control PRBs higher weight and therefore less likelihood of being overwritten. Certain PRBs may be assigned a weight between 1 and 10 if, for example, it corresponds to an optionally used control region (e.g., a weight of 2), or may exceed a weight of 10 if, for example, it corresponds to a critical control or reference signal region. According to one embodiment, any PRB with a weight above a certain threshold (e.g., 5) is restricted from being overwritten with an injected signal or traffic interrupt. In one embodiment, the threshold may be predetermined by a network operator. An example of weights 1 to 10 is given, but other values or scales could be used, and the sum total could go higher than the weight applied to any individual PRB. Utilization can also be mapped in number format (e.g., as percentage utilization). Based on this map, and as described further herein, the O-RU function can then make the best choice possible in where to inject AC signals with the least projected impact on the traffic. The example is given of weighting blocks in the control region higher than other traffic. Higher weighting can be implemented in control regions, or other regions, or sub-regions according to user preference or need to prioritize certain regions of traffic. Normalization can also be applied to the weighting of PRBs. For example, the mapping (such as in FIGS. 1A-1D) can be implemented as (PRB weight/PRB max weight). Such an embodiment would compare each individual PRB weight to the maximum PRB weight in the entire mapping. Such embodiments can allow a user to set a threshold value e.g., only PRBs with normalize weights below a threshold value will receive a signal injection or traffic interrupt.

The utilization, as exemplified in FIGS. 1A-1D, needs to be averaged over some time frame (a number of radio frames) which poses a design trade-off. A longer averaging time frame gives better accuracy in the average utilization estimate, but at the same time it uses older data which might be less accurate if the traffic load and type has changed.

The PRB utilization at each instant can be found in at least three different ways: analyzing O-RAN C-plane message content about PRB allocation; analyzing O-RAN C-plane message content about beamforming; or analyzing O-RAN U-plane data.

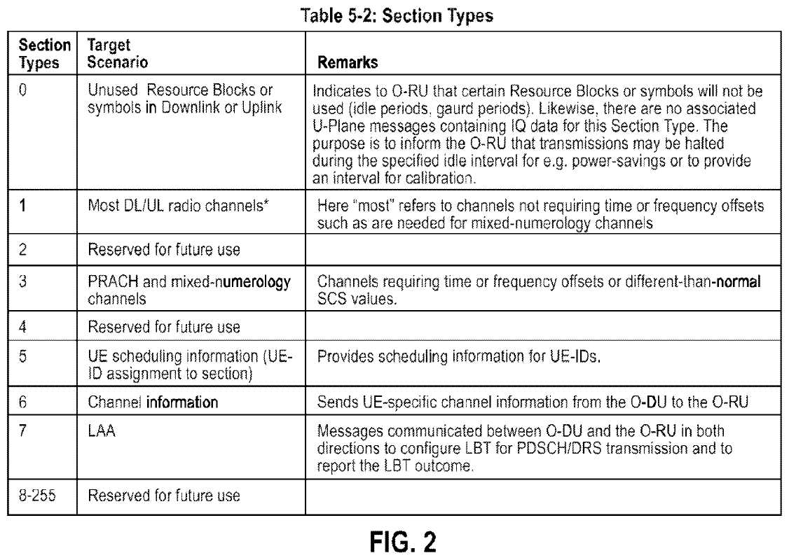

In a first example, O-RAN C-plane message content about PRB allocation can be analyzed. For this method, the C-plane preferably contains enough information that can be utilized in the mapping. O-RAN C-plane contains scheduling information for different section types, such as listed in FIG. 2. FIG. 2 shows DL or UL unused symbol indications in O-RAN C-plane. Whereas section “0” indicates unused resource blocks or symbols in DL or UL, other sections can indicate per-PRB scheduled traffic. This approach assumes that the C-plane features are fully and correctly implemented by the O-DU vendor. Unused resource block information could for example be omitted since it can be seen as a non-critical information (the system should function even if this is never indicated).

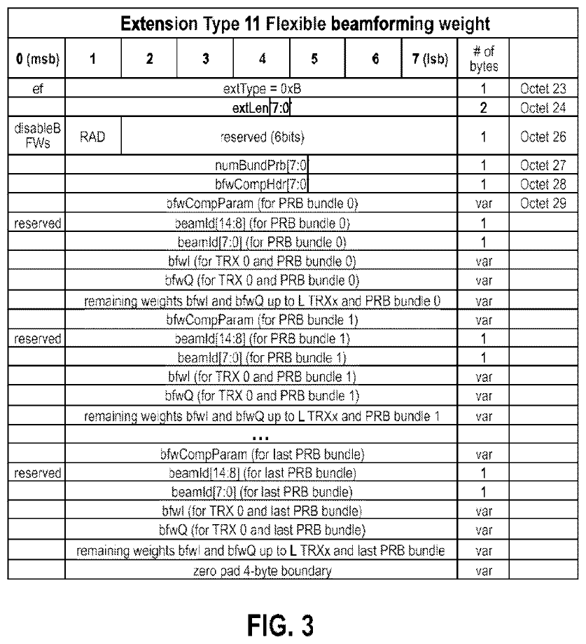

In a second example, O-RAN C-plane message content about beamforming can be analyzed. A beamforming index or beamforming weights provide useful information from the O-RAN C-plane. This can be a beamforming index as an indication to what type of traffic a symbol contains. Also, ORAN C-plane content can include actual beam weights sent from O-DU to O-RU. For example, section extension type 11 is shown in FIG. 3. FIG. 3 shows DL or UL unused symbol indications in ORAN C-plane. Using such weights, beamforming weight IQ power(s) per PRB and antenna can be calculated. A thresholding is then applied to check if the PRB has enough power to be considered used or not.

As a third example, the O-RAN U-plane data can be analyzed directly. Since the O-RU receives from and/or transmits to the O-DU frequency-domain IQ data, the time-frequency grid components can be straightforwardly measured by calculating the IQ signal power per PRB. In DL direction the measurement can be done in L1 before iFFT and could be considered ideal due to the large dynamic range at this interface. In the UL direction, measurement can be done after FFT and the useful dynamic range may be limited by noise and interference from the UL radio chains. A thresholding can be applied on the uplink data in order to decide if a certain PRB is utilized or not.

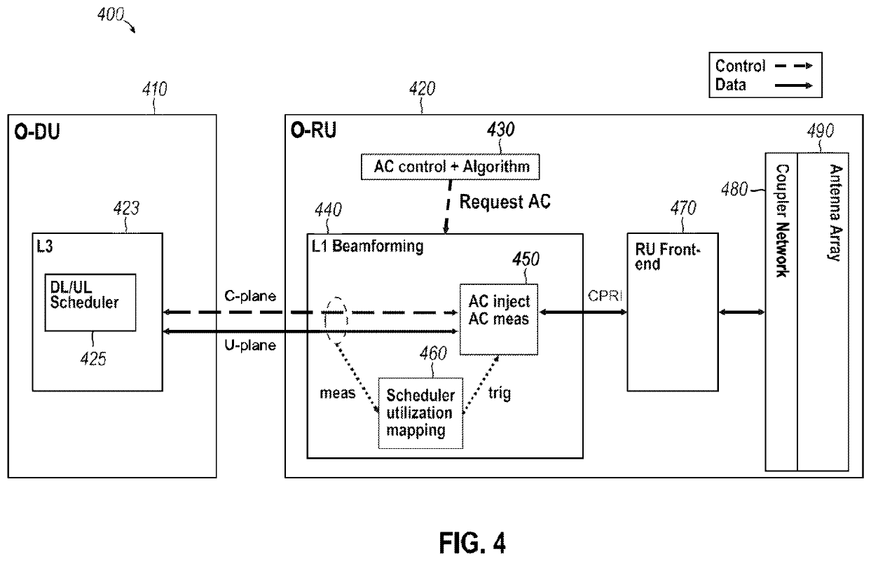

FIG. 4 displays one possible system embodiment 400 under the present disclosure. System 400 can comprise a massive MIMO radio with an O-DU 410 and an O-RU 420. Alternatively, system 400 could comprise distributed components within a broader system. O-DU 410 can be operating at L3 423 and can comprise a DL/UL Scheduler 425. Data sent by the O-DU 410 can be on both the C-plane and the U-plane and be received by O-RU 420 at the AC unit 450 within the L1 Beamforming unit 440. Scheduler 460 can measure and/or analyze the data being sent before it enters the AC unit 450. Scheduler 460 can perform mapping and/or other utilization analysis. Scheduler 460, based on its mapping/analysis can trigger the AC unit to inject an AC signal at an appropriate time based on the predictions/analysis/mapping of the scheduler 460. L1 Beamforming unit 440 can also receive AC control and algorithm information from AC control 430. AC control 430, among other functions, can decide that AC is needed, overdue, or otherwise desired. L1 Beamforming unit 440 can transmit the resulting signal over the CPRI (common public radio interface) to the RU front end 470. From there, the RU front end can communicate with the coupler network 480 and the antenna array 490. From there signals will be sent to user devices, mobile devices, and/or other devices or components.

When the traffic/PRB utilization map is generated by the scheduler 460, it can be used by the AC unit to decide the best injection placement in relation to the generated utilization map. An input to this decision is the minimum length required for each AC inject window. The shorter the inject window, the better the inject timepoint can be matched to the utilization map. It should also be noted that the frequency dimension can in principle be used in the AC inject resolution. If the AC inject can be done on certain PRBs only, then the best AC inject point can be based on a full two-dimensional map of the PRB utilization. If the AC inject must be done on the full carrier BW, the best AC inject point should be based on a one-dimensional projection of the full PRB utilization map onto a time dimension.

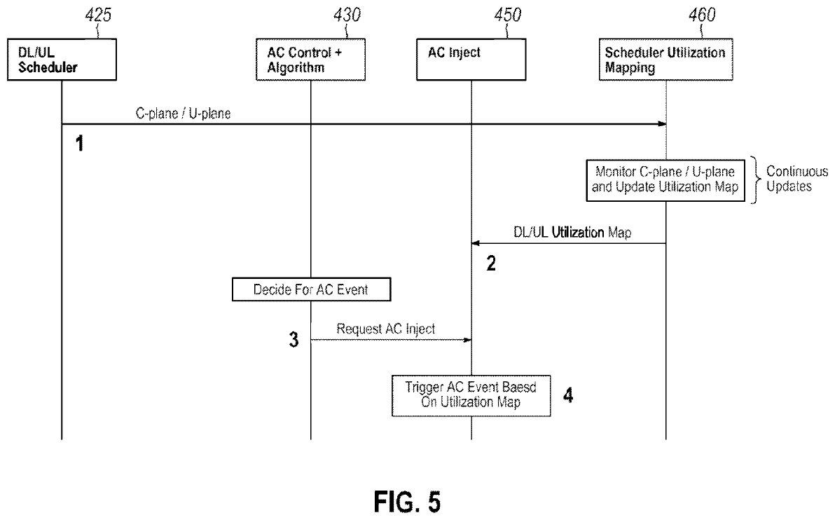

FIG. 5 shows a flow-chart representation of some of the functionalities described with respect to FIG. 4. DL/UL Scheduler sends C-Plane and U-plane messages at step 1 that are constantly being analyzed by the scheduler 460. Scheduler 460 can be constantly mapping the utilization and constantly updating this map and other data. Scheduler 460 can provide the map, or other data representation to the AC unit 450. At any moment, the AC unit 450 may receive a command/request from the AC control 430 to inject an AC signal. AC unit 450, based on the command/request, and the utilization map/data from the scheduler 460, can inject an AC signal as best deemed appropriate, hopefully into an empty frame, or a frame predicted to be empty or to have as little amount of traffic as possible.

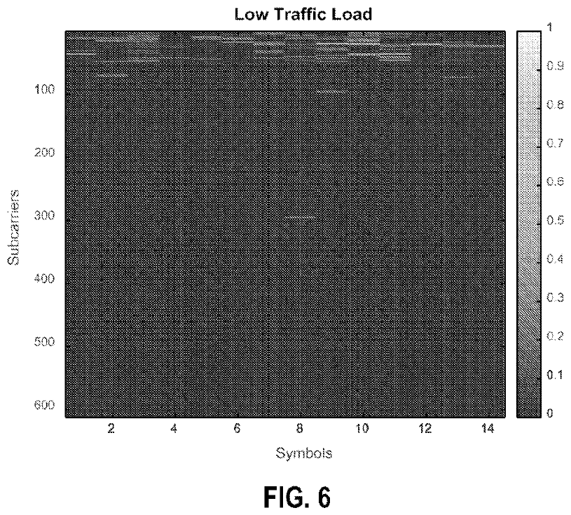

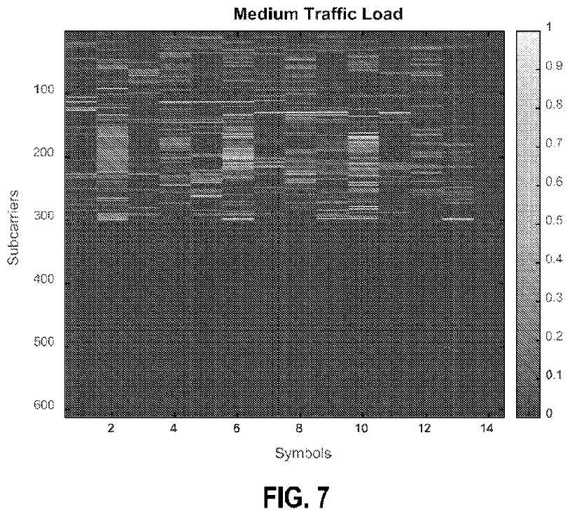

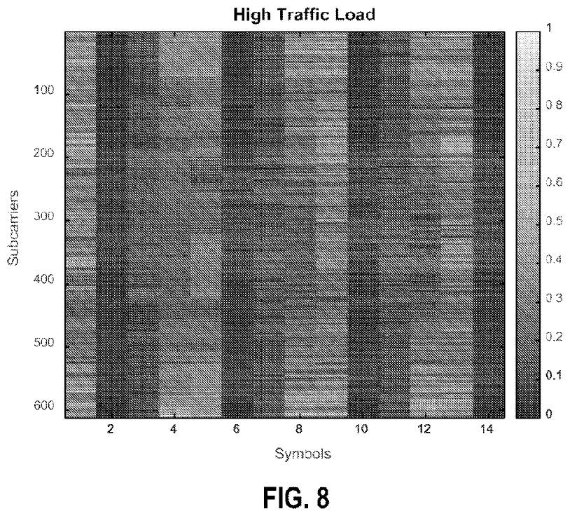

FIGS. 6 to 8 show example patterns for high/middle/low traffic load cases, generated from system simulations. In each figure, power level is indicated by the shade variation from dark to light, while the darker means less traffic and the lighter means higher traffic with higher power in those resource blocks. Note there are multiple users in these cases so the higher power the more layers/users data are scheduled in those blocks. From those patterns it is seen that it's easy to find the empty PRBs in the middle or low traffic load cases. It's also possible to find the empty PRBs even in high traffic load case. It makes sense because the network would try to schedule the traffic to some certain PRBs which provide the best performance while avoiding using the ones with low performance.

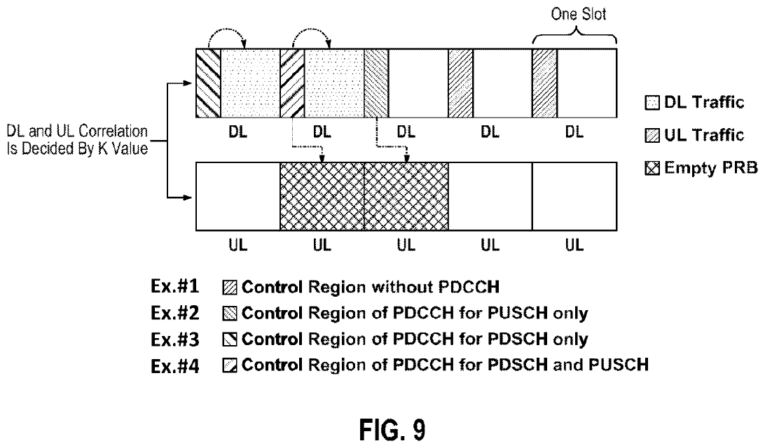

Further embodiments under the present disclosure can predict PRB utilization according to the IQ signal power pattern of the region of control signals, i.e., coreset in NR. In either 5G or 4G RAN, the physical downlink control channel (PDCCH) can transmit the DCI (Downlink Control Information), which can be used for scheduling DL (e.g., PDSCH (physical downlink shared channel)) and UL (e.g., PUSCH (physical uplink shared channel)) data channels. Analyzing the IQ signal power pattern of the control signals can help determine if there are empty PRBs or resources for AC injection. FIG. 9 shows four methods of performing this analysis.

Example #1 is a control region without PDCCH. Under this scenario there is no DL and UL traffic in the corresponding PDSCH or PUSCH regions. Hence AC signals can be injected into those empty DL and UL symbols. The pattern of this case is that the IQ signal power would be zero or minimum.

Example #2 is a control region with PDCCH for PUSCH only. Under this scenario there is no DL traffic in the corresponding PDSCH regions. Hence AC signals can be injected into the empty DL symbols. The pattern of this case can be found according to the DCI format of PDCCH. According to 3GPP 38.212 Table 7.3.1-1 (reproduced below), gNB would send DCI format 0_x for PUSCH scheduling. Please note that different DCI formats might have different patterns in the control region.

Example #3 is a control region with PDCCH for PDSCH only. Under this scenario there is no UL traffic in the corresponding PDSCH regions. Hence AC signals can be injected into the empty UL symbols. According to 3GPP 38.212 Table 7.3.1-1, gNB would send DCI format 1_x for PDSCH scheduling. Please note that different DCI formats might have different patterns in the control region.

Example #4 is a control region of PDCCH for both PUSCH and PDSCH. Under this scenario there is DL and UL traffic in the corresponding PDSCH and PUSCH regions. Hence AC signals shall not be injected into the corresponding DL or UL symbols. According to 3GPP 38.212 Table 7.3.1-1, gNB would send both DCI format 0_x & 1_x in this case.

TABLE 7.3.1-1
DCI Formats

| DCI format | Usage |
|---|---|
| 0_0 | Scheduling of PUSCH in one cell |
| 0_1 | Scheduling of one or multiple PUSCH in one cell, or |
| | indicating downlink feedback information for configured |
| | grant PUSCH (CG-DFI) |
| 0_2 | Scheduling of PUSCH in one cell |
| 1_0 | Scheduling of PDSCH in one cell |
| 1_1 | Scheduling of PDSCH in one cell, and/or triggering one |
| | shot HARQ-ACK codebook feedback |
| 1_2 | Scheduling of PDSCH in one cell |

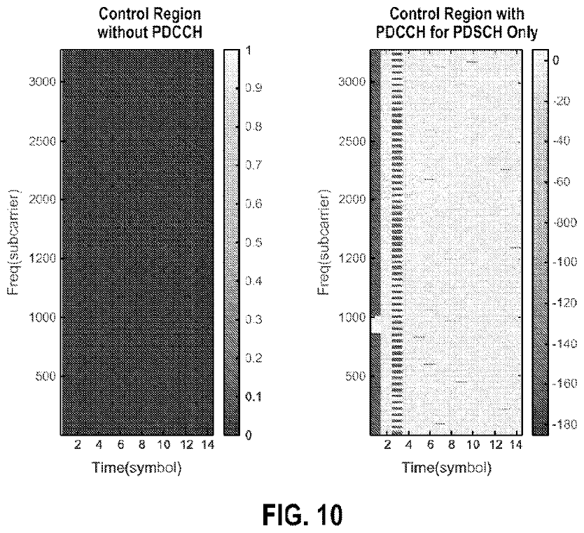

To identify which of the four preceding scenarios to implement, the IQ signal power of frequency and time grid can be analyzed. The information of time and frequency domain power level and used number of PRB, position of used PRB, etc., could be used to determine the PDDCH/DCI format and corresponding scenarios. FIG. 10 shows two examples for Examples #1 and #2 in DL slots. There is no IQ signal power in symbol 1 (control region) for Example #1, while there are two CCEs (Control Channel Element) transmitted in symbol 1 for Example #2. Accordingly, the corresponding empty PRBs can be found to inject the AC signals.

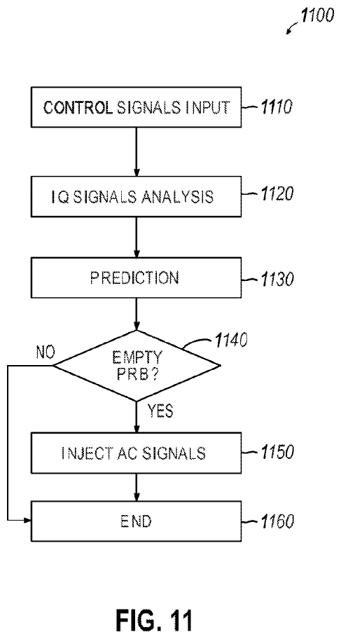

FIG. 11 shows one method embodiment illustrating Examples #1-#4. At step 1110, control signals input can be received. At step 1120, IQ signals analysis is performed. At 1130, a prediction is made of when an empty PRB will be available. At 1140, it is determined if the predicted PRB is empty. If not, then the process goes to step 1160 and ends, or alternatively repeats from step 1110. If the PRB is empty, then at 1150 the AC signal is injected. And then at 1160 the process ends.

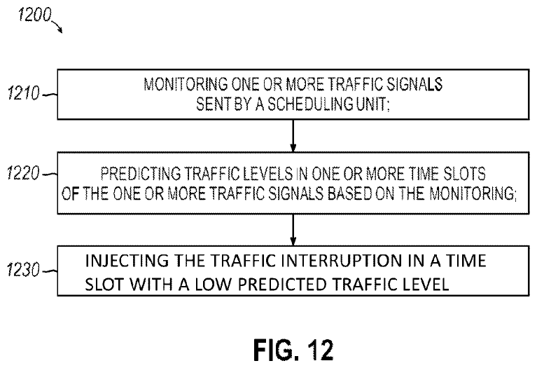

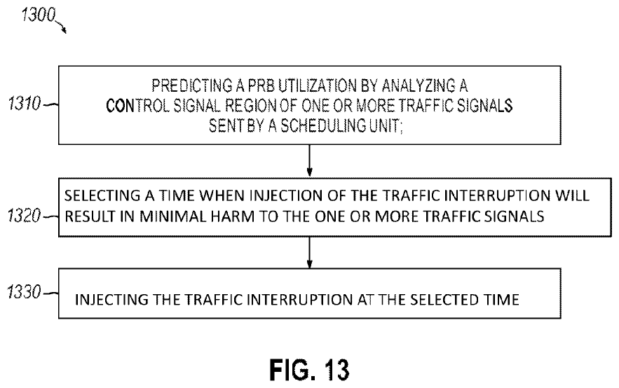

FIGS. 12 and 13 show further possible method embodiments under the present disclosure.

Method 1200 in FIG. 12 is a method performed by a radio unit for semi-blindly interrupting traffic signals (e.g., injecting a test or calibration signal, or injecting a period of silence). Step 1210 is monitoring one or more traffic signals sent by a scheduling unit. Step 1220 is predicting traffic levels in one or more time slots (and optionally one or more frequency bandwidth parts) of the one or more traffic signals based on the monitoring. Step 1230 is injecting the traffic interruption in a time slot (and optionally in a bandwidth part) with a low predicted traffic level. A bandwidth part may include the bandwidth of a single PRB or coarser, e.g., up to a full carrier bandwidth. For example, in some embodiments a test signal or period of silence does not need to span a full carrier bandwidth and may instead be injected in a bandwidth part that spans less than a full carrier bandwidth. Injecting a traffic interruption in a bandwidth part will cover a chosen number of time slots. How many time slots are interrupted when injecting in a bandwidth part can depend on user preferences or system design. Injection could be performed in one time slot, two time slots, or any chosen number.

Method 1300 in FIG. 13 is a method performed by a radio unit for inserting a traffic interruption, such as described in relation to FIGS. 9-11. Step 1310 is predicting a PRB utilization by analyzing a control signal region of one or more traffic signals from a scheduling unit. Step 1320 is selecting a time when injection of the traffic interruption will result in minimal harm to the one or more traffic signals. Step 1330 is injecting the traffic interruption at the selected time.

While some description herein has discussed the injection of a test signal, a test signal can include calibration, probe, control, sample, experimental, and/or other types of test signals.

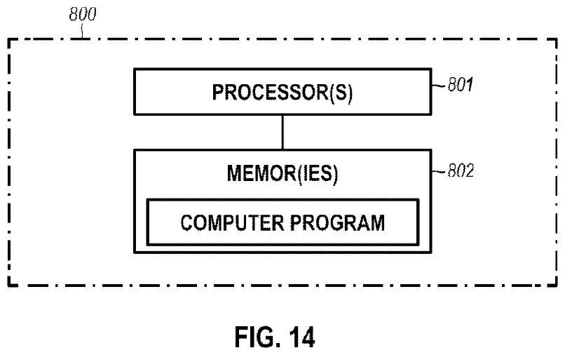

FIG. 14 shows a schematic block diagram of a radio device 800 according to embodiments of the present disclosure. Radio device 800 can comprise a massive MIMO radio, base station, DU/RU, or other node or component within a RAN. Radio device 800 may comprise at least a processor 801 and at least a memory 802. Memory 802 may have stored thereon a computer program which, when executed on the processor 801, causes the processor 801 to carry out any of the methods performed in the radio device 800 according to the present disclosure.

The memory may be, e.g., an Electrically Erasable Programmable Read-Only Memory (EEPROM), a flash memory and a hard drive. The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules could in alternative embodiments be distributed on different computer program products in the form of memories within the UE or the network nodes. In an embodiment of the present disclosure, there is provided a computer-readable storage medium having stored thereon a computer program which, when executed on at least one processor, causes the at least one processor to carry out the method according to the present disclosure.

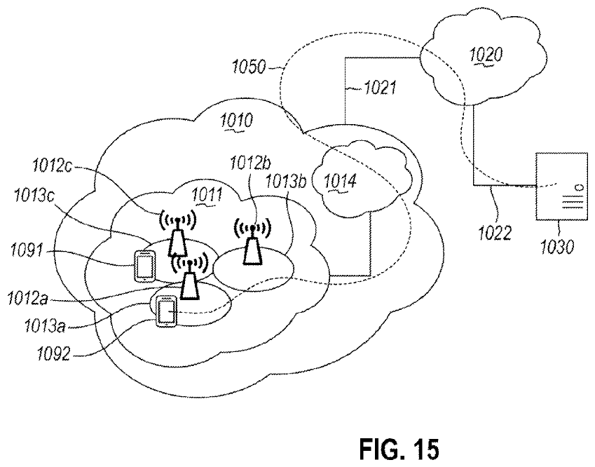

FIG. 15 schematically illustrates a telecommunication network connected via an intermediate network to a host computer. With reference to FIG. 15, in accordance with an embodiment, a communication system includes a telecommunication network 1010, such as a 3GPP-type cellular network, which comprises an access network 1011, such as a radio access network, and a core network 1014. The access network 1011 comprises a plurality of base stations 1012a, 1012b, 1012c, such as NBs, eNBs, gNBs or other types of wireless access points, each defining a corresponding coverage area 1013a, 1013b, 1013c. Each base station 1012a, 1012b, 1012c is connectable to the core network 1014 over a wired or wireless connection 1015. A first user equipment (UE) 1091 located in coverage area 1013c is configured to wirelessly connect to, or be paged by, the corresponding base station 1012c. A second UE 1092 in coverage area 1013a is wirelessly connectable to the corresponding base station 1012a. While a plurality of UEs 1091, 1092 are illustrated in this example, the disclosed embodiments are equally applicable to a situation where a sole UE is in the coverage area or where a sole UE is connecting to the corresponding base station 1012.

In one embodiment, the access network 1011 includes ORAN access nodes. An ORAN access node is a node in the access network that is compliant with an ORAN specification (e.g., a specification published by the O-RAN Alliance) and may operate alone or together with other nodes to implement the functionality of an access network node. Examples of an ORAN access node include an O-RU, an O-DU, an open central unit (control plane or user plane), a RAN intelligent controller (real time or non-real time) hosting an xApp or an rApp, or any combination thereof. The ORAN access node may be compliant with a specification by, for example, supporting an interface defined by the specification, such as an A1, F1, W1, E1, E2, X2, Xn interface, an open fronthaul user plane interface, or an open fronthaul management plane interface. Moreover, the ORAN access node may be one of multiple logical nodes (as opposed to a physical node) in a physical node.

The telecommunication network 1010 is itself connected to a host computer 1030, which may be embodied in the hardware and/or software of a standalone server, a cloud-implemented server, a distributed server or as processing resources in a server farm. The host computer 1030 may be under the ownership or control of a service provider, or may be operated by the service provider or on behalf of the service provider. The connections 1021, 1022 between the telecommunication network 1010 and the host computer 1030 may extend directly from the core network 1014 to the host computer 1030 or may go via an optional intermediate network 1020. The intermediate network 1020 may be one of, or a combination of more than one of, a public, private or hosted network; the intermediate network 1020, if any, may be a backbone network or the Internet; in particular, the intermediate network 1020 may comprise two or more sub-networks (not shown). The communication system of FIG. 15 as a whole enables connectivity between one of the connected UEs 1091, 1092 and the host computer 1030.

A radio device 800 (of FIG. 14) may comprise any base station 1012a, 1012b, 1012c within FIG. 15. Each such radio device 800 may comprise the elements and functionalities described in relation to FIG. 4. Alternatively, radio device 800 may comprise one or more aspects of FIG. 4 and other aspects and/or functionalities of FIG. 4 may be located at other locations. For example, O-DU 410 and O-RU 420 do not necessarily have to be co-located. With reference to FIG. 15, O-DU 410 and O-RU 420 could be located at different base stations 1012a, 1012b, 1012c or elsewhere within core network 1014, intermediate network 1020 or host computer 1030.

### Computer Systems of the Present Disclosure

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The memory may take any form and may depend on the nature and form of the computing system. The memory can be physical system memory, which includes volatile memory, non-volatile memory, or some combination of the two. The term “memory” may also be used herein to refer to non-volatile mass storage such as physical storage media.

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof.

For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages—so as to generate such binary that is directly interpretable by a processor.

The term “executable component” is also well understood by one of ordinary skill as including structures that are implemented exclusively or near-exclusively in hardware logic components, such as within a field programmable gate array (FPGA), an application specific integrated circuit (ASIC), Program-specific Standard Products (ASSPs), System-on-a-chip systems (SOCs), Complex Programmable Logic Devices (CPLDs), or any other specialized circuit. Accordingly, the term “executable component” is a term for a structure that is well understood by those of ordinary skill in the art of computing, whether implemented in software, hardware, or a combination thereof.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In an embodiment, the communication system may include a complex of computing devices executing any of the method of the embodiments as described above and data storage devices which could be server parks and data centers.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

Accordingly, embodiments described herein may comprise or utilize a special purpose or general-purpose computing system. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example—not limitation-embodiments disclosed or envisioned herein can comprise at least two distinctly different kinds of computer-readable media: storage media and transmission media.

Computer-readable storage media include RAM, ROM, EEPROM, solid state drives (“SSDs”), flash memory, phase-change memory (“PCM”), CD-ROM or other optical disk storage, magnetic disk storage or other magnetic storage devices, or any other physical and tangible storage medium that can be used to store desired program code in the form of computer-executable instructions or data structures and that can be accessed and executed by a general purpose or special purpose computing system to implement the disclosed functionality or functionalities. For example, computer-executable instructions may be embodied on one or more computer-readable storage media to form a computer program product.

Transmission media can include a network and/or data links that can be used to carry desired program code in the form of computer-executable instructions or data structures and that can be accessed and executed by a general purpose or special purpose computing system. Combinations of the above should also be included within the scope of computer-readable media.

Further, upon reaching various computing system components, program code in the form of computer-executable instructions or data structures can be transferred automatically from transmission media to storage media (or vice versa). For example, computer-executable instructions or data structures received over a network or data link can be buffered in RAM within a network interface module (e.g., a “NIC”) and then eventually transferred to computing system RAM and/or to less volatile storage media at a computing system. Thus, it should be understood that storage media can be included in computing system components that also—or even primarily—utilize transmission media.

Those skilled in the art will further appreciate that a computing system may also contain communication channels that allow the computing system to communicate with other computing systems over, for example, a network. Accordingly, the methods described herein may be practiced in network computing environments with many types of computing systems and computing system configurations. The disclosed methods may also be practiced in distributed system environments where local and/or remote computing systems, which are linked through a network (either by wired data links, wireless data links, or by a combination of wired and wireless data links), both perform tasks. In a distributed system environment, the processing, memory, and/or storage capability may be distributed as well.

Those skilled in the art will also appreciate that the disclosed methods may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

The following abbreviations are used in the present disclosure:
PDCCH Physical downlink control channel
PDSCH Physical downlink shared channel
PUCCH Physical uplink control channel
PUSCH Physical uplink shared channel
PRB Physical resource block
DCI Downlink control information
CCEs Control Channel Element
UL Uplink
DL Downlink
AC Antenna Calibration
ML Machine Learning
IQ In-phase/Quadrature
DU Digital unit
RU Radio unit
O Open
RAN Radio access network
MIMO Multiple input multiple output
L1 Layer one
L3 Layer three
iFFT Inverse fast Fourier transform)
FFT Fast Fourier transform
LLS-U Lower Layer Split User-plane
LLS-C Lower Layer Split Control-plane
IQ In phase/quadrature

### CONCLUSION

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by preferred embodiments, exemplary embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

All references cited in this application are hereby incorporated in their entireties by reference to the extent that they are not inconsistent with the disclosure in this application. It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be effected to the particular embodiments by those of skill in the art without departing from the scope of the description, which is defined solely by the appended claims.

1. A method performed by a radio unit for semi-blindly interrupting traffic signals, the method comprising:
monitoring one or more traffic signals sent by a scheduling entity;
predicting traffic levels in one or more time slots of the one or more traffic signals based on the monitoring; and
injecting a traffic interruption in a time slot with a low predicted traffic level.

2. The method of claim 1 further comprising predicting traffic levels in one or more frequency bandwidth parts of the one or more traffic signals.

3. The method of claim 2 wherein injecting a traffic interruption further comprises injecting in a frequency bandwidth part with a low predicted traffic level.

4. The method of claim 1 wherein injecting a traffic interruption comprises injecting at least one of a test signal and a period of silence.

5. (canceled)

6. The method of claim 1 wherein the monitoring comprises measuring traffic utilization and mapping it to an average physical resource block (PRB) utilization table with dimensions of at least time and frequency.

7. The method of claim 1 wherein the monitoring comprises mapping at least one of downlink traffic and uplink traffic.

8. (canceled)

9. The method of claim 1 wherein the monitoring comprises mapping traffic at one or more layers and summing the mapping to assess allocation for all layers.

10. The method of claim 1 wherein predicting traffic levels includes predicting the time and frequency location of control signals and weighting the control signals as corresponding to a higher traffic level than other traffic when determining if a predicted traffic level is low enough for injection of the test signal.

11. The method of claim 1 wherein the monitoring comprises averaging resource utilization over a predetermined time frame.

12. The method of claim 6 wherein the monitoring further comprises analyzing ORAN (open radio access network) C-plane message content about at least one of PRB allocation and beamforming index information.

13. (canceled)

14. The method of claim 6 wherein the monitoring further comprises analyzing ORAN U-plane data.

15. The method of claim 1 wherein the predicting is based at least in part on a minimum length required for each test signal inject window.

16. The method of claim 1 wherein if the test signal can be injected only on certain PRBs, then the predicting is based at least in part on a two-dimensional map of PRB utilization, wherein the two dimensions comprise time and frequency.

17. The method of claim 1 wherein if the test signal must be injected on full carrier bandwidth, then the predicting is based at least in part on a one-dimensional projection of full PRB utilization map onto time dimension.

18-19. (canceled)

20. A method performed by a radio unit for inserting a traffic interruption, the method comprising:
predicting a PRB utilization by analyzing a control signal region of one or more traffic signals sent by a scheduling unit;
selecting a time when injection of the traffic interruption will result in minimal harm to the one or more traffic signals; and
injecting the traffic interruption at the selected time.

21. The method of claim 20 wherein injecting the traffic interruption comprises injecting at least one of: a test signal and a period of silence.

22. (canceled)

23. The method of claim 20 wherein predicting a PRB utilization includes at least one of:
predicting there is no downlink traffic in a PDSCH, wherein the injecting is performed in empty downlink symbols if no downlink traffic in the PDSCH is predicted and;
predicting there is no uplink traffic in a PUSCH (physical uplink shared channel), wherein the injecting is performed in the empty uplink symbols if no uplink traffic in the PUSCH is predicted.

24. (canceled)

25. The method of claim 20 wherein predicting a PRB utilization includes predicting there is downlink traffic in a PDSCH and uplink traffic in a PUSCH, and wherein the injecting is performed elsewhere than downlink and uplink symbols corresponding to the analyzed control signal region if downlink traffic and uplink traffic are predicted.

26. (canceled)

27. The method of claim 20 wherein the radio unit performs the injection at layer one and the scheduling unit operates at layer three.

28. A radio unit, comprising,
a processor; and
a memory having stored thereon a computer program which, when executed on the processor, causes the processor to carry out the method according to claim 1.

29.-30. (canceled)
